(19) United States
(12) Patent Application Publication
(10) Pub. No.: US 2016/0159630 A1
(43) Pub. Date: Jun. 9, 2016

(54) TOOL FOR GRASPING AND HANDLING AN ARTICLE

(71) Applicant: Armin FURRER, Luzern (CH)

(72) Inventor: Armin FURRER, Luzern (CH)

(21) Appl. No.: 14/948,654

(22) Filed: Nov. 23, 2015

(30) Foreign Application Priority Data
Dec. 6, 2014 (EP) 14196680.4

(51) Int. Cl. B67B 7/18; A47J 45/10

(52) U.S. Cl. CPC B67B 7/184; A47J 45/10

(57) ABSTRACT

The tool, which serves for grasping and handling an article, particularly for opening a container, includes a sheet-like or plate-shaped tool body that is made from an elastic plastic material. The tool body is a hollow cylindrical element that forms a closed loop or that the tool body includes at ends opposing one another connecting elements that are complementary to one another and with which the tool body can be fixed in the form of a hollow cylindrical element and that the tool body in the form of the hollow cylindrical element includes at least on the inner side a slip-resistant surface. The tool allows securely holding and manipulating, particularly opening, the container. After use, the tool body can be drawn in the form of a jacket sleeve over the forearm of the user and can be kept ready there for the next use.

The invention relates to a tool for grasping and handling an article, particularly for removing a cover from a container.

### BACKGROUND OF THE INVENTION

In prior art numerous tools are known, which allow opening a vessel or a container. The tools serve in particular for establishing a firm connection with the cover of the container, so that the cover can then be turned and slippage is avoided.

US20030061912A1 discloses a bottle cap removal device with a lever with an opening therein to receive a bottle cap, including a top and a base which combine to provide an envelope for the bottle cap removal device and including an annular member and a surface opposed to the annular member operative to apply increased gripping forces on the bottle cap upon relative rotation between the annular member and bottle cap.

US20060216472A1 discloses a container opening tool including first and second legs hingedly secured to one another. Each leg has proximal and distal portions each having an aperture wall including a gripping material. The aperture walls form of the first and second legs are positionable to form proximal and distal apertures, in which containers can be held.

US20080072709A1 discloses a container top opener with a hand gripping portion and a concave container top gripping portion. The device has a series of tapered gripping ribs which allow the device to be used on a wide range of container top sizes. The gripping ribs are directionally inclined such that the tighter a user twists the device, the more securely the gripping ribs bite into the container top and assist the user in untightening and removing the container top.

US20130298508A1 discloses a handheld jar opener device has a handle and a strap extending from near a corner of the front and one side of the handle. The strap is formed into a loop in front of the handle, and extends through a tunnel disposed diagonally through the handle from near a corner of the front and an opposite side of the handle to the one side of the handle, with a residual portion of the strap extending beyond the handle. The device may engage the lid of a jar, or the body of the jar.

Although the described tools allow, grasping and removing different closures or covers from a container, their range of applications is strongly limited. Besides said opening functions, the known tools do not comprise further useful functions, which could for example be of advantage particularly together with the opened containers, e.g. in the working area of a kitchen. Furthermore, these tools are often not reachable, when they are required.

Furthermore, these tools need to be cleaned regularly with considerable effort.

Further, it is particularly disadvantageous that by means of these tools the cover, but not the container itself can securely be grasped. If the tool and, hence, the grasped cover is turned with one hand, it often happens that the container cannot securely be held with the other hand, so that the application of the tool does not deliver the desired result.

A further disadvantage of known solutions is that during the process of opening a container typically considerable force is applied, which on the one side acts on the closure and on the other side on the container. As soon as the cover or closure and the container are getting disengaged under the impact of a high force, they can get accelerated. Possibly, the container is fitfully pushed forward, so that content stored therein gets spilled out. The container or the closure may even fall to the floor.

It must be further noted, that with conventional tools hot containers and vessels can normally not be manipulated and opened. The tool can scarcely be applied and the hot container cannot be held securely.

Hence, the application range for conventional tools is strongly limited. Furthermore, handling of these tools is not efficient. Further, tools exhibit often a complex structure and are thus expensive in production. Further, maintenance and cleaning of these tools may require considerable efforts.

### SUMMARY OF THE INVENTION

The invention is based on the object of providing an improved tool. In particular, a tool shall be created, which serves for opening a container and which fulfils further functions, which are helpful particularly in the field of gastronomy. It shall be possible to carry and clean the tool with little effort.

It would further be desirable, if the tool could selectively be adapted to a specific function or to a specific purpose of application, particularly to different dimensions of containers.

This object is reached with a tool that comprises the features defined in claim 1. Preferred embodiments of the invention are described in further claims.

The tool, which serves for grasping and handling an article, particularly for opening a container, comprises a sheet-like or plate-shaped tool body that is made from an elastic plastic material. The tool body is a hollow cylindrical element that forms a closed loop. Alternatively, the tool body comprises at ends, opposing one another, connecting elements that are complementary to one another and with which the tool body can be fixed in the form of a hollow cylindrical element. In the form of the hollow cylindrical element, the tool body comprises at least on the inner side a slip-resistant surface.

The tool exhibits a simple structure, can cost-efficiently be produced and can be applied in many different ways. The tool can efficiently be applied and easily be handled by all groups of users, including elderly people. Due to the numerous possibilities of application, e.g. in the kitchen of a restaurant, high efficiency and high benefit result.

The tool allows advantageous handling of objects, particularly containers. Containers and vessels, which are closed with a rotatably mounted cover, can easily be opened. Thereby it is avoided that after disengagement the container and the closure can get out of control and fall onto the floor.

A container to be manipulated is inserted into the elastic and easily deformable cylinder element until the container and its closure are enclosed by the tool body. Then, the container and the closure can be grasped with the tool body, can be held without slippage, and can be turned against one another. After the container is opened a connection, which is formed by the tool body, remains between the container and the closure. Hence, the container and the closure can securely be held, and will not fall to the floor or perform jerky movements.

Further, it is particularly advantageous that due to its insulating properties the tool can also be applied on hot containers and vessels, in order to manipulate them, e.g. for opening. Hence, the user does not get in contact with the hot container and does not require any additional auxiliary means.

With tools of the prior art however the container must be held, e.g. with a fabric, before the tool can be coupled with the closure and can be turned. Then, often slippage between the fabric and the container occurs, so that the container cannot be opened.

The tool body of the applied inventive tool can be deformed and be adapted on the one side to the diameter of the container and on the other side to the diameter of the closure. Hence, the inventive tool allows opening different containers, which differ with regard to the dimensions of the containers and of the closures. Hence, the inventive tool allows opening containers, particularly bottles that comprise closures, which can be turned and thereby released from the container. E.g., also a cork can be removed from a bottle by grasping it with the tool and turning it while simultaneously pulling it to the outside.

As mentioned, the tool body exhibits at least at the inner side, i.e. the side facing the container, a slip-resistant surface, so that slippage between container and cover on the one side and the tool body on the other side is excluded.

However, in a preferred embodiment also the outer side, i.e. the side of the tool body facing the hand of the user, is provided with a slip-resistant surface. Thereby, slippage is also avoided between the outer side of the tool body and the hand of the user.

Anti-slip property is reached by a suitable selection of the materials and/or by structuring or profiling the surface of the tool body.

In a preferred embodiment the tool body in the form of the cylinder element is provided at least at the inner side with a slip-resistant profile. The slip-resistant profile can advantageously also be provided at the inner side and the outer side of the tool body. Further, different profiles can be provided at the base sides of the tool body that are opposing one another, so that the user can swap the inner side and the outer side of the tool body against one another and can always use the preferred profile.

In preferred embodiments the tool body is manipulated such that the inner side and the outer side can be swapped. The tool body consists for example of a flexible baseplate, whose opposite sides can be connected with one another by connecting elements. Hence, the end pieces of the tool body can be turned into one or the other direction and can be connected with one another with the connecting elements.

Alternatively, the tool body, which exhibits the form of a tube or hose and which is closed in itself, can be turned from inside to outside due to its high flexibility provided for this function, so that the outer side of the tool body becomes its inner side.

In preferred embodiments, the tool body comprises, e.g. on the one or the other side slip-resistant structural elements or structural forms, such as longitudinal ribs, grooves, waves, saw-tooth forms or pyramids. The structural elements can engage in recesses provided in the container or in the closure or cover, whereby not only a force-locking, but also a form-locking connection results, which allows turning the container and the closure or cover against one another without slippage.

Preferably, the structural elements and structural forms extend on the inner side and the outer side of the tool body at least approximately in parallel to one another. In this embodiment the tool body exhibits not only slip-resistant structures on both sides, but also a high elasticity. E.g., by a wave-shaped design of the tool body, the tool body forms a spring, which can be extended. The tool body consists in preferred embodiments of a stretchable elastic plastic. Alternatively or in addition the tool body exhibits a stretchable structure. Recesses in the material are provided for example such that a framework, e.g. a framework in the form of a honeycomb remains. Thereby the connections of the ribs form joints, which allow deformation of the tool body.

Such a material framework can advantageously be provided between two insulating layers, which cover the recesses in the material.

Recesses in the material or a weakening of the tool body can advantageously be provided in the central range of the tool body. The central range of the tool body forms in this case a kind of a joint that allows to turn the lower part of the tool body, which embraces the container, and the upper part of the tool body, which embraces the closure, against one another.

The tool body can advantageously be pre-tensioned in order to facilitate the release of the closure. For this purpose, the tool body is turned at one end in the closing direction without grasping the closure. As soon as the tool body is tensioned, the closure is grasped and turned into the other direction. Consequently pre-tension and muscle force of the user are acting then together on the closure.

In further preferred embodiments the tool body comprises a thermally insulating structure, which can also be reached e.g. with recesses in the material. E.g., the tool body is provided with a plurality of hollow spaces, which are closed or open towards the outside. The tool body comprises for example a honeycomb structure, which is closed or open towards one side or both sides.

In particularly preferred embodiments the tool body comprises a plurality of hollow channels, which traverse the tool body in parallel or inclined to the longitudinal axis and which are closed or open in one direction. These longitudinal channels provide a high flexibility to the tool body. Furthermore, longitudinal channels that are open on the upper side act slip-resistant. Hence, by providing recesses in the material slip-resistant properties and thermal insulating properties can be reached.

In addition or alternatively, the tool body can be made from a thermally insulating and preferably fireproof plastic.

Hence, the tool allows manipulating hot items. A hot pan or a hot baking tray can be grasped and transported. In addition the tool can also be used as support for hot items, e.g. in order to protect a table.

The tool body preferably consists of a single layer, which can easily and cost-efficiently be manufactured by an extrusion process or an injection moulding process.

In further preferred embodiments the tool body consists of a laminate with a plurality of layers. For example fire-proof and abrasion-resistant outer layers are provided that are relatively thin and that enclose an elastic intermediate layer, which is thicker. Further, a less abrasion-resistant intermediate layer made from rubber or natural rubber or an intermediate layer with recesses can be enclosed between two abrasion-resistant elastomer layers.

The tool body or at least one of the layers of the tool body is preferably made from a heat-resistant and preferably fire-proof elastomer, such as fluororubber, Neoprene or silicone.

The tool body is tailored as required in the field of application. In industrial fields, in which larger objects are manipulated, larger dimensions are selected than in the field of households, in which bottles, tins and cans, pans and other vessels and bowls are manipulated.

The tool body exhibits for example a thickness in the range of approximately 0.4 mm-10 mm. For the household thicknesses in the range of 0.4 mm-1 mm are particularly advantageous. With these dimensions, the tool body is light and flexible and can be handled easily by everybody.

In the normal form of the cylinder element the tool body exhibits a cylinder diameter preferably in the range of approximately 75 mm-200 mm and a cylinder height preferably in the range of approximately 100 mm-250 mm.

As mentioned above, the tool fulfils numerous advantageous functions, of which some have been described above. However, the tool exhibits further advantageous properties and functions.

Due to the design in the form a flexible thin-walled hollow cylinder the tool can advantageously be pulled over the forearm and be kept ready for further use. If required the tool is pulled over the hand, which then, protected by the tool, can grasp and manipulate a hot article. It is particularly advantageous that the hand is protected all-around. When reaching into an oven, e.g. a bowl can be grasped without fearing that the back of the hand gets in contact with a hot part of the oven. Thereby, the tool acts as a glove, which after manipulating the article need not be pulled off, but can be drawn back over the forearm.

Structuring and profiling the inner side of the tool body, which is facing the forearm of the user is also advantageous for another reason. The tool body is lying on the forearm, while air can circulate between the forearm and the tool body.

The preferred design of the tool with a wave-structure provides enough elasticity so that the tool can conveniently be pulled over the hand and while it is still not obstructive when performing further work. The elastic tool surrounds the forearm, without causing inconvenient pressure onto the arm. The tool remains also in a desired position when the arm is hanging. The wave-structure simultaneously provides sufficient air circulation, so that in this position unpleasant sweating is avoided.

It is therefore not necessary to deposit the tool at a storage place and to fetch it or search for it again, but it is always ready for use without disturbing. This is particularly helpful in the kitchen, in which normally only little space is available and objects are manipulated in short sequences. The tool does not require space, which is required otherwise, it never gets lost and it is ready for use within seconds.

### DESCRIPTION OF THE INVENTION

Below, the invention is described with reference to the drawings. Thereby show:

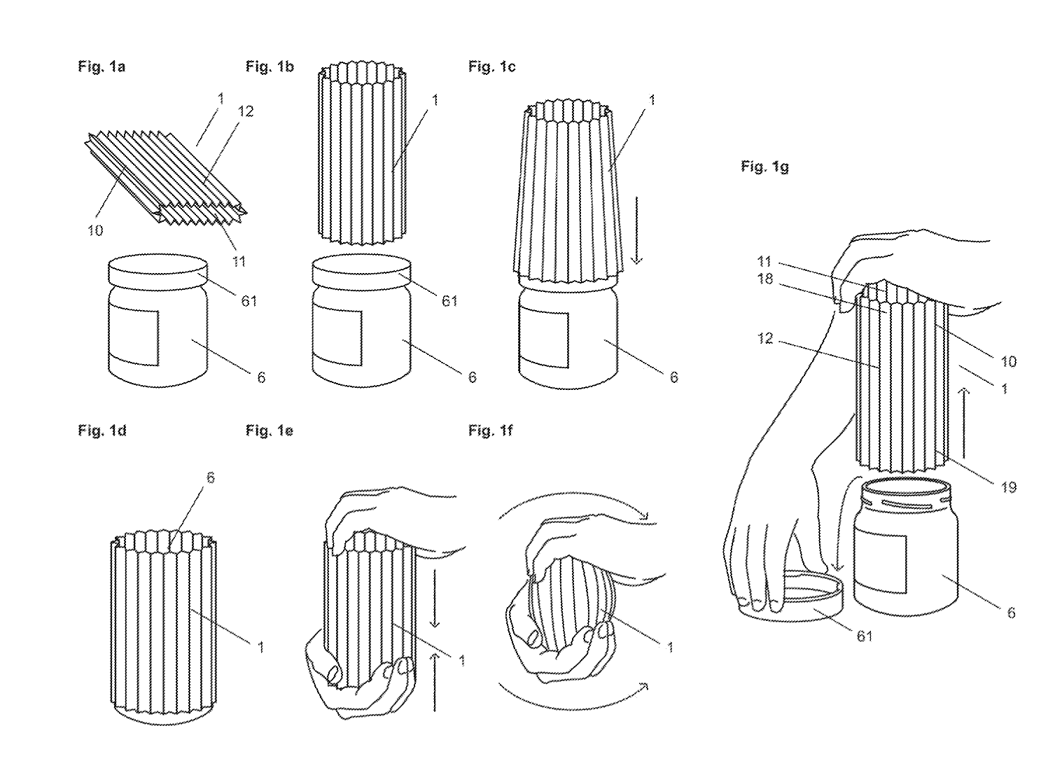

FIG. 1a an inventive elastic tool 1 as well as a glass container 6 that is closed with a cover 61;

FIG. 1b the container 6 and the tool of FIG. 1a in cylindrical form;

FIG. 1c pulling the tool 1 over the container 6;

FIG. 1d the container 6 with the tool 1 pulled over;

FIG. 1e grasping the container 6 held in the tool 1 with the right hand and grasping the cover 61 of the container 6 with the left hand;

FIG. 1f turning of the glass container 6 held in the tool 1 and of the cover 61 in opposite directions;

FIG. 1g the opened container 6 and the cover 61 removed from the tool 1;

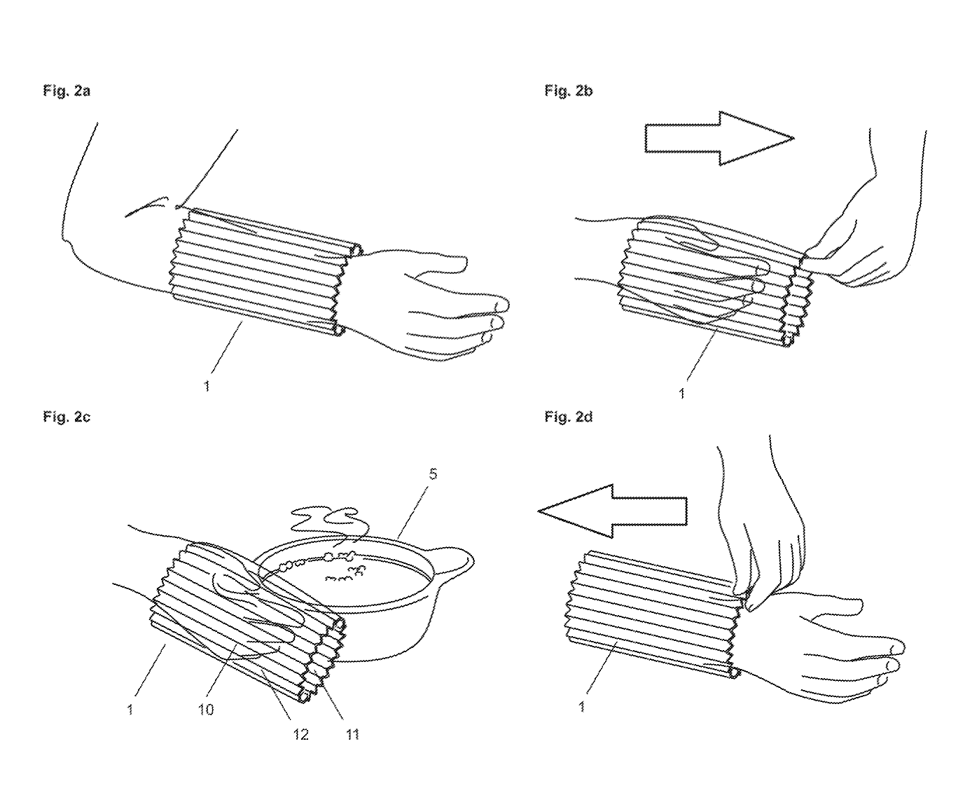

FIG. 2a the tool 1 of FIG. 1a in the embodiment of a sleeve, which has been pulled over the forearm of the user and which can be worn in this way until it is required for use;

FIG. 2b positioning the tool 1 over the right hand;

FIG. 2c grasping a hot container 5 with the right hand, which is protected by the tool 1;

FIG. 2d movement of the tool 1 after use into the region of non-operation, in which the tool 1 surrounds the forearm of the user again;

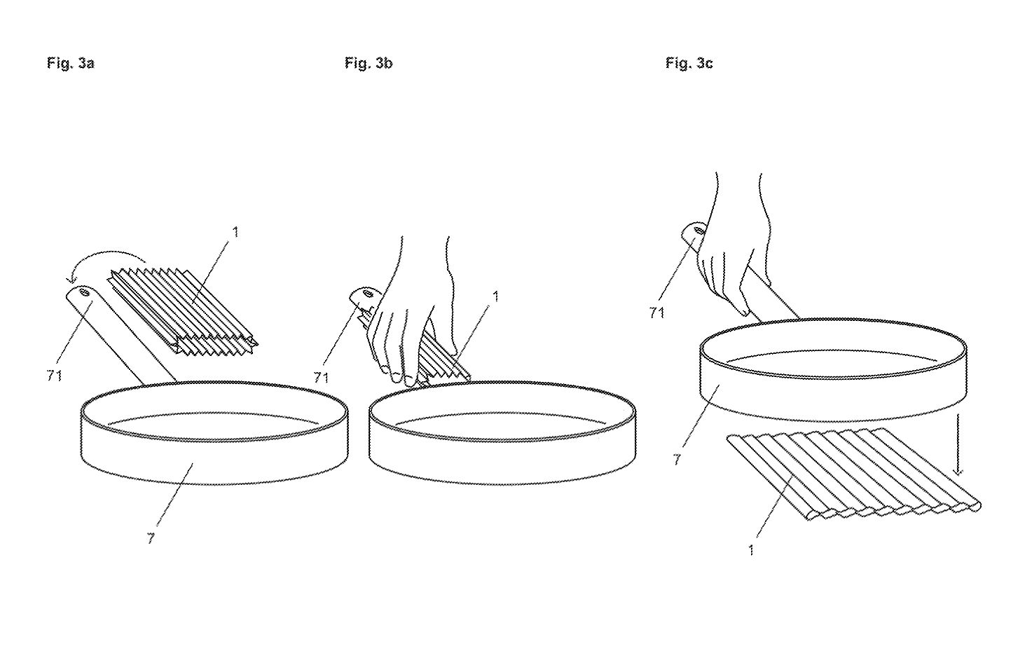

FIG. 3a the tool 1 of FIG. 1a as well as a pan 7 with a panhandle 71;

FIG. 3b the pan 7 with the tool 1 pulled over the panhandle 71;

FIG. 3c the pan 7 with the tool 1 as underlayer;

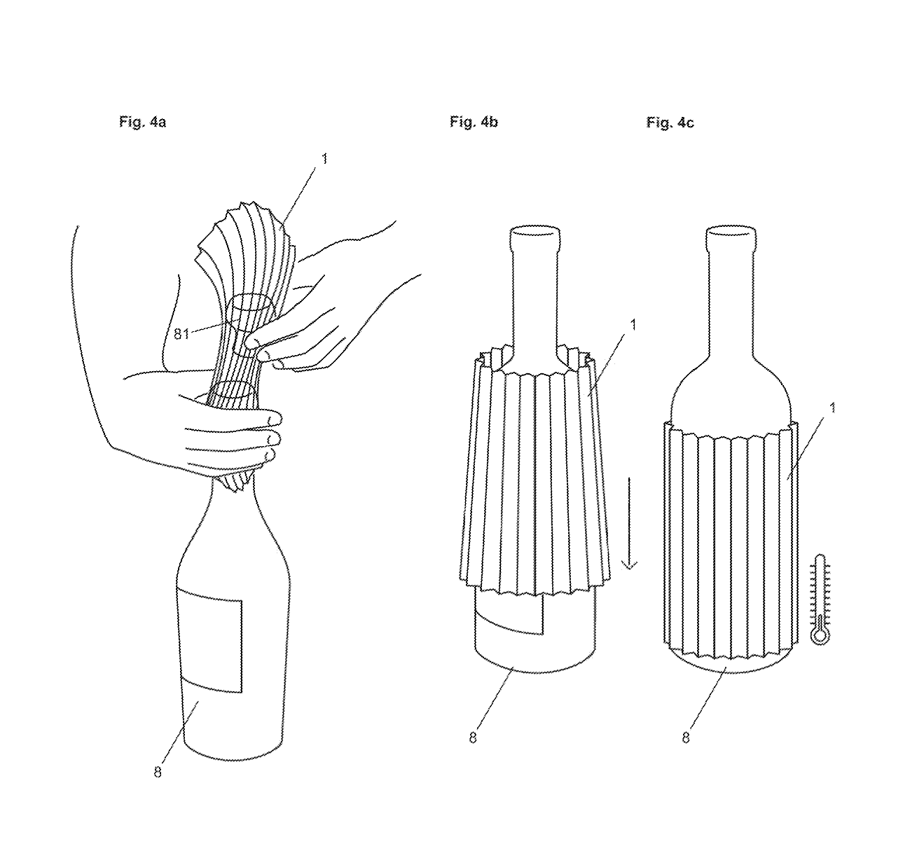

FIG. 4a the tool 1 of FIG. 1a being pulled over the neck of a bottle 8 with the closure or cork 81 released from the bottle 8;

FIG. 4b the tool 1 while being pulled over the bottle 8;

FIG. 4c the bottle 8 with the tool 1 pulled over;

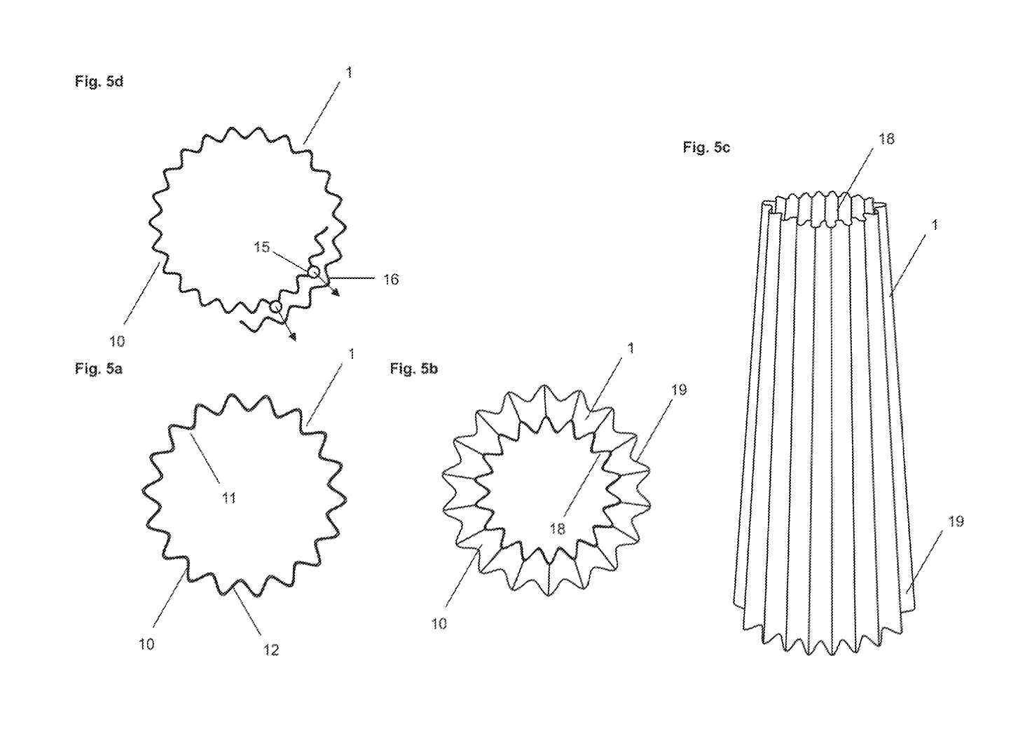

FIG. 5a a cross-section of the tool 1;

FIG. 5b seen from above the tool of FIG. 1 expanded on the lower side;

FIG. 5c the tool 1 of FIG. 5b seen from the side; and

FIG. 5d a preferred embodiment of a tool 1, which is designed as an elastic plate and which is provided with connecting elements 15, 16 that allow connecting two opposing sides of the tool 1 with one another, whereby the form of a cylinder element or sleeve results as shown in FIG. 2a.

FIG. 1a shows the tool 1 as well as a glass container 6 that is closed with a cover 61. The tool 1 comprises plate-shaped tool body 10, which is closed in itself and has been folded to a cuboid. The tool body 10 exhibits a cross-section with a saw-tooth-form or wave-form, wherefore the upper side and the lower side or the inner side 11 and the outer side 12, respectively, of the tool body 10 extend in parallel to one another in saw-tooth-form or wave-form. The resulting profile allows securely grasping articles. During the application of the tool 1 a slip-resistant connection results on one side between the container and the closure and the tool body and on the other side between the hands of the user and the tool body.

The tool body 10 consists for example of a silicone layer, which can be produced advantageously with an extrusion process. Due to the selected material and the form the tool body is slip-resistant and thermally insulating.

FIG. 1b shows the glass container 6 as well as the tool of FIG. 1a in cylindrical form. Hence, the tool 1 can be brought into different forms, in which it is adapted to an article that requires manipulation.

FIG. 1c shows the tool 1 being pulled over the container 6 and FIG. 1d shows the container 6 with tool 1 pulled over.

FIG. 1e shows grasping of the container 6, which is held in the tool 1, with the right hand and grasping of the cover 61 of the container 6 with the left hand and FIG. 1f shows turning of the glass container 6, which is held in the tool 1, and the cover 61 in opposite directions. Hence, by means of the tool 1, the glass container 6 and the cover 61 can be held and turned without slippage. The tool 1 adapts under manual pressure to the container 6 and the cover 61. Hence, with the tool 1 different containers 6 can be manipulated, which exhibit dimensions that significantly deviate from one another.

FIG. 1g shows the opened container 6 and the cover 61, which has been removed from the tool 1.

FIG. 2a shows the tool 1 of FIG. 1a in cylindrical form or in the embodiment of a sleeve, respectively, which has been pulled over the forearm of the user and can be worn in this way, until its application is required. In this situation a further advantage of the profiling of the inner side 11 of the tool body 10 can be noticed. The profile at the inner side 11 of the tool body 10 allows the circulation of air, so that moisture can be removed from the forearm of the user, when the tool is worn at the forearm.

Particularly advantageous is a spring-elastic embodiment of the tool body 10, which is preferably wave-shaped or saw-tooth-shaped. Hence, the tool body can elastically adapt to the forearm of the user and can easily be pulled over and removed again.

FIG. 2b shows the tool 1 being pulled forward out of the position shown in FIG. 2a and positioned over the right hand.

In this position a hot container 5 can be grasped with the right hand, which is protected by the tool 1, e.g. in an oven and taken out as shown in FIG. 2c.

FIG. 2d shows that after use the tool 1 can be returned to the non-operation position over the forearm of the user. In this position of the tool 1, the user has his hands free and can do his work without obstruction. Space for depositing the tool 1 is not required. As well, the tool 1 cannot get lost.

FIG. 3a shows the tool 1 of FIG. 1 as well as a hot pan 7 with a panhandle 71. FIG. 3b shows the pan 7 with the tool 1 pulled over the panhandle 71. Hence, the tool 1 serves as thermal insulation for the panhandle 71. FIG. 3c shows the pan 7 with the tool 1 as underlayer.

Hence, the tool 1 can advantageously be used for manipulating pans and further cooking equipment. A cook for example can pull the tool 1 from his forearm to manipulate a pan and to place the pan on the insulating tool 1, so that the pan does not cool down on a substrate of stone or metal.

FIG. 4a shows the tool 1, which has been pulled over the neck of a bottle 8 with the closure or cork 81 that has been released from the bottle 8. This shows a further advantage of the tool 1, which can be compressed to the small diameter of the bottle neck and of the cork 81 of the bottle 8.

Particularly elegant is a further use of the tool 1, which serves for keeping a liquid cool inside a bottle 8. After opening the bottle the tool 1 is brought back into cylindrical form and is moved over the body of the bottle 8 as shown in FIGS. 4b and 4c. Due to the insulating effect of the tool 1 the bottle 8 is kept cool.

FIG. 5a shows the inventive tool 1 with the cross-section of the tool body in a wave-shaped or saw-tooth form. Hence, in this embodiment a parallel direction of pattern is present at the inner side 11 and the outer side 12 of the tool body 10. The tool body 10 forms an extendable spring that can easily be pulled over the forearm of the user.

FIG. 5b shows the tool 1 of FIG. 1, which has been expanded on one side, from above and FIG. 5c shows the tool 1 of FIG. 5b from the side. The upper end piece 18 has a smaller diameter than the lower end piece 19. This difference of diameters can be caused under the impact of force or can be embossed into the structure of the tool body 10.

Often the closure of a container has a smaller diameter than the body of the container, which can advantageously be taken into account by a reduction of the diameter of the tool 1 from one end 18 to the other end 19. Further, the transition between a first and a second diameter can be done stepwise.

FIG. 5d schematically shows a preferred embodiment of the tool 1, which is formed as an elastic plate and which is provided with connecting elements 15, 16 that allow connecting two sides of the tool, which are opposites to one another, whereby the form of a cylinder element or a sleeve results as shown in FIG. 2a.

The connecting elements 15, 16 can have a simple design. E.g., at one end piece of the tool body 10 spherical connecting elements 15 may be provided, which can be entered into slit openings 16, which are provided at the second end piece of the tool body 10. Alternatively, complementary parts of snap fasteners can be provided at the end pieces.

1. A tool for grasping and handling an article with a sheet-like or plate-shaped tool that is made from an elastic plastic material, wherein the tool body is a hollow cylindrical element that forms a closed loop or that the tool body comprises at ends opposing one another connecting elements that are complementary to one another and with which the tool body can be fixed in the form of a hollow cylindrical element and that the tool body in the form of the hollow cylindrical element comprises at least on the inner side a slip-resistant surface.

2. The tool according to claim 1, wherein the tool body, when in the form of the hollow cylindrical element, is provided at the inner side and/or the outer side with a slip-resistant profile or that both sides of the tool body comprise different slip-resistant profiles.

3. The tool according to claim 1, wherein the inner side and/or the outer side of the tool body comprises slip-resistant structural elements.

4. The tool according to claim 1, wherein the tool body is made from a stretchable elastic plastic and/or that the tool body exhibits a stretchable structure.

5. The tool according to claim 4, wherein the tool body exhibits a wave-shaped or saw-tooth-shaped cross-section.

6. The tool according to claim 1, wherein the tool body exhibits a thermally insulating structure and/or is made at least partially from thermally insulating plastic.

7. The tool according to claim 1, wherein the tool body comprises a plurality of hollow spaces that are open or closed towards the outside and/or that the tool body comprises a plurality of hollow channels, which traverse the tool body in parallel or inclined to the longitudinal axis.

8. The tool according to claim 1, wherein the tool body consists of a single layer or that the tool body consists of a laminate with a plurality of laminate layers.

9. The tool according to claim 8, wherein at least one of the laminate layers, which is enclosed between two other ones of the laminate layers, is provided with recesses.

10. The tool according to claim 1, wherein the tool body or at least one of the laminate layers is made from temperature-resistant elastomer.

11. The tool according to claim 1, wherein the tool body is made by an extrusion process or by injection moulding.

12. The tool according to claim 1, wherein the diameter of the tool body shrinks gradually or stepwise from one cylinder end to the other cylinder end in a range of approximately 10%-50%.

13. The tool according to claim 1, wherein the tool body exhibits a thickness in a range of approximately 0.4 mm-10 mm.

14. The tool according to claim 1, wherein the tool body in cylindrical form exhibits a cylinder diameter in a range of approximately 75 mm-250 mm, which cylinder diameter is adapted to the handled article.

15. The tool according to claim 1, wherein the tool body in cylindrical form exhibits a cylinder height in a range of approximately 100 mm-250 mm, which cylinder height is adapted to the handled article.
